(19) United States
(12) Patent Application Publication
(10) Pub. No.: US 2026/0362150 A1
(43) Pub. Date: Nov. 12, 2026

(54) UE-AWARE RADIO RESOURCE ALLOCATION IN DYNAMIC SPECTRUM SHARING

(71) Applicant: Telefonaktiebolaget LM Ericsson (publ), Stockholm (SE)

(72) Inventors: Ho Ting Cheng, Stittsville (CA); ZhongMing Zheng, Stittsville (CA); Saad Naveed Ahmed, Sundbyberg (SE); Xuegui Song, Ottawa (CA)

(21) Appl. No.: 19/123,924

(22) PCT Filed: Dec. 2, 2022
(86) PCT No.: PCT/IB2022/061709

§ 371 Date: Apr. 24, 2025

(51) Int. Cl. H04W 16/14; H04W 36/22; H04W 72/12; H04W 72/566

(52) U.S. Cl. CPC H04W 16/14; H04W 36/22; H04W 72/1215; H04W 72/569

(57) ABSTRACT

Systems and methods are disclosed for User Equipment (UE) aware radio resource allocation for Dynamic Spectrum Sharing (DSS) between Radio Access Technologies (RATs). In one embodiment, a method performed by shared resource allocator for UE-aware radio resource allocation for DSS between a first scheduler for a first RAT and a second scheduler for a second RAT comprises determining, for a first observation window, a value of a traffic or demand related metric based on scheduling requests received from the first and second schedulers during the first observation window. The method further comprises selecting a prioritization pattern from a set of prioritization patterns based on the determined value of the metric and performing radio resource allocation for the first and second schedulers based on the selected prioritization pattern.

### TECHNICAL FIELD

The present disclosure relates to Dynamic Spectrum Sharing (DSS) in a cellular communications system.

### BACKGROUND

In a 3^{rd} Generation Partnership Project (3GPP) system utilizing Dynamic Spectrum Sharing (DSS) between Long Term Evolution (LTE) and New Radio (NR), a shared resource allocator is employed to decide how radio resources are allocated to LTE and NR per timeslot. One existing DSS radio resource allocation solution uses a pattern-based resource allocation approach where, in each timeslot, radio resource allocation priority is assigned to either LTE or NR according to a static predefined pattern. This Radio Access Technology (RAT)-based resource allocation is critical in ensuring successful NR Physical Downlink Control Channel (PDCCH) allocation and hence providing good uplink (UL) performance for NR.

With a fair splitting policy, the current RAT-based approach splits radio resources between LTE and NR more or less equally. This RAT-based approach is desired if the number of LTE User Equipments (UEs) and the number of NR UEs are roughly the same. If one RAT has more UEs than the other, however, per-UE resource allocation becomes unbalanced.

There is a desire for a UE-aware resource allocation scheme, as opposed to the existing RAT-based resource allocation scheme, so that regardless of RATs, each UE in a pair of DSS cells (e.g., an LTE cell and a NR cell paired for DSS) is assigned more or less the same radio resources. Still further, there is a desire for UE-aware resource allocation scheme that does not degrade uplink performance in a DSS cell (e.g., either of an LTE cell and a NR cell paired for DSS).

### SUMMARY

Systems and methods are disclosed for User Equipment (UE) aware radio resource allocation for Dynamic Spectrum Sharing (DSS) between Radio Access Technologies (RATs). In one embodiment, a method performed by a shared resource allocator for UE-aware radio resource allocation for DSS between a first scheduler for a first RAT and a second scheduler for a second RAT comprises determining, for a first observation window comprising a first plurality of timeslots, a value of a traffic or demand related metric based on scheduling requests received from the first scheduler for the first RAT during the first observation window and scheduling requests received from the second scheduler for the second RAT during the first observation window. The method further comprises selecting an prioritization pattern from a set of two or more prioritization patterns based on the determined value of the traffic or demand related metric for the first observation window, wherein each prioritization pattern in the set of two or more prioritization patterns is associated to a different value of the traffic or demand related metric and each prioritization pattern in the set of two or more prioritization patterns defines a pattern of first timeslots in which the first RAT is prioritized and second timeslots in which the second RAT is prioritized. The method further comprises performing radio resource allocation for the first scheduler for the first RAT and the second scheduler for the second RAT based on the selected prioritization pattern. By appropriately designing the prioritization patterns, UE-aware radio resource allocation is provided without negatively impacting uplink performance.

In one embodiment, performing radio resource allocation for the first scheduler for the first RAT and the second scheduler for the second RAT based on the selected prioritization pattern comprises, for each timeslot of a second plurality of timeslots in a second observation window, firstly allocating radio resources in the timeslot to one of the first RAT and the second RAT that is prioritized in a respective timeslot of the selected prioritization pattern. In one embodiment, performing radio resource allocation for the first scheduler for the first RAT and the second scheduler for the second RAT based on the selected prioritization pattern further comprises, for each timeslot of the second plurality of timeslots in a second observation window, if there are any remaining radio resources in the timeslot after firstly allocating radio resources in the timeslot to the one of the first RAT and the second RAT that is prioritized in a respective timeslot of the selected prioritization pattern, secondly allocating at least a portion of the remaining resources in the timeslot to one of the first RAT and the second RAT that is not prioritized in the respective timeslot of the selected prioritization pattern. In one embodiment, the method further comprises providing, to the first scheduler of the first RAT, information that indicates the radio resources in the timeslot that are assigned to the first RAT and providing, to the second scheduler of the second RAT, information that indicates the radio resources in the timeslot that are assigned to the second RAT.

In one embodiment, the method further comprises determining, for the second observation window comprising the second plurality of timeslots, a second value of the traffic or demand related metric based on scheduling requests received from the first scheduler for the first RAT during the second observation window and scheduling requests received from the second scheduler for the second RAT during the second observation window. The method further comprises selecting a new prioritization pattern from the set of two or more prioritization patterns based on the second value of the traffic or demand related metric determined for the second observation window and performing, for a third plurality of timeslots, radio resource allocation for the first scheduler for the first RAT and the second scheduler for the second RAT based on the selected new prioritization pattern.

In one embodiment, for each prioritization pattern in the set of two or more prioritization patterns, the number of first timeslots and the number of second timeslots in the prioritization pattern is a function of the associated value of the traffic or demand related metric.

In one embodiment, selecting the prioritization pattern from the set of two or more prioritization patterns based on the determined value of the traffic or demand related metric for the first observation window comprises selecting one of the set of two or more prioritization patterns for which the associated traffic or demand related metric most closely matches the traffic or demand related metric for the first observation window as the prioritization pattern to be used for performing radio resource allocation for the first scheduler for the first RAT and the second scheduler for the second RAT.

In one embodiment, selecting the prioritization pattern from the set of two or more prioritization patterns based on the determined value of the traffic or demand related metric for the first observation window comprises selecting at least two candidate prioritization patterns from the set of two or more prioritization patterns based on the associated traffic or demand related metrics and the traffic or demand related metric for the first observation window. Selecting the prioritization pattern further comprises, for each candidate prioritization pattern from the at least two candidate prioritization patterns, assigning a weight to the candidate prioritization pattern based on the associated traffic or demand related metric and the traffic or demand related metric for the first observation window. Selecting the prioritization pattern further comprises selecting the prioritization pattern to be used for performing radio resource allocation for the first scheduler for the first RAT and the second scheduler for the second RAT from the at least two candidate prioritization patterns in such a manner that a probability of selecting each candidate prioritization pattern of the at least two candidate prioritization patterns is a function of the weight assigned to the candidate prioritization pattern.

In one embodiment, determining the value of the traffic or demand related metric for the first observation window comprises, for each timeslot of the first plurality of timeslots comprised in the first observation window, determining a value of the traffic or demand related metric for the timeslot based on scheduling requests received from the first scheduler for the first RAT for the timeslot and scheduling requests received from the second scheduler for the second RAT for the timeslot. Determining the value of the traffic or demand related metric for the first observation window further comprises combining the values of the traffic or demand related metric for the first plurality of timeslots to provide the value of the traffic or demand related metric for the first observation time window. In one embodiment, combining the values of the traffic or demand related metric for the first plurality of timeslots to provide the value of the traffic or demand related metric for the first observation time window comprises averaging the values of the traffic or demand related metric for the first plurality of timeslots to provide the value of the traffic or demand related metric for the first observation time window as an average value of the traffic or demand related metric. In one embodiment, for each timeslot of the first plurality of timeslots comprised in the first observation window, determining the value of the traffic or demand related metric for the timeslot is further based on priorities assigned to traffic associated to the scheduling requests received from the first scheduler for the first RAT for the timeslot and priorities assigned to traffic associated to the scheduling requests received from the second scheduler for the second RAT for the timeslot.

In one embodiment, the traffic or demand related metric for the first observation window is an average ratio of a number of radio resources needed to satisfy the scheduling requests from the first scheduler for the first RAT to a number of radio resources needed to satisfy the scheduling requests from the second scheduler for the second RAT per timeslot.

In one embodiment, the traffic or demand related metric for the first observation window is an average ratio of a number of radio resources needed to satisfy the scheduling requests from the second scheduler for the second RAT to a number of radio resources needed to satisfy the scheduling requests from the first scheduler for the first RAT per timeslot.

In one embodiment, the traffic or demand related metric for the first observation window is an average ratio of a number of radio resources needed to satisfy the scheduling requests from the first scheduler for the first RAT to a total number of radio resources needed to satisfy the scheduling requests from both the first scheduler for the first RAT and the second scheduler for the second RAT, per timeslot.

In one embodiment, the traffic or demand related metric for the first observation window is an average ratio of a number of radio resources needed to satisfy the scheduling requests from the second scheduler for the second RAT to a total number of radio resources needed to satisfy the scheduling requests from both the first scheduler for the first RAT and the second scheduler for the second RAT, per timeslot.

In one embodiment, the traffic or demand related metric for the first observation window is based on: (a) priorities of the first RAT and the second RAT, (b) buffer size of UE data buffers of UEs of the first RAT and buffer sizes of UE data buffers of UEs of the second RAT, (c) number of UEs of the first RAT and number of UEs of the second RAT, (d) number of data radio bearers across UEs of the first RAT and number of data radio bearers across UEs of the second RAT, or (e) a combination any to two or more of (a)-(d).

Corresponding embodiments of a network node are also disclosed. In one embodiment, a network node for UE-aware radio resource allocation for DSS between a first scheduler for a first RAT and a second scheduler for a second RAT is adapted to determine, for a first observation window comprising a first plurality of timeslots, a value of a traffic or demand related metric based on scheduling requests received from the first scheduler for the first RAT during the first observation window and scheduling requests received from the second scheduler for the second RAT during the first observation window. The network node is further adapted to select an prioritization pattern from a set of two or more prioritization patterns based on the determined value of the traffic or demand related metric for the first observation window, wherein each prioritization pattern in the set of two or more prioritization patterns is associated to a different value of the traffic or demand related metric and each prioritization pattern in the set of two or more prioritization patterns defines a pattern of first timeslots in which the first RAT is prioritized and second timeslots in which the second RAT is prioritized. The network node is further adapted to perform radio resource allocation for the first scheduler for the first RAT and the second scheduler for the second RAT based on the selected prioritization pattern.

In one embodiment, a network node for UE-aware radio resource allocation for DSS between a first scheduler for a first RAT and a second scheduler for a second RAT comprises processing circuitry configured to cause the network node to determine, for a first observation window comprising a first plurality of timeslots, a value of a traffic or demand related metric based on scheduling requests received from the first scheduler for the first RAT during the first observation window and scheduling requests received from the second scheduler for the second RAT during the first observation window. The processing circuitry is further configured to cause the network node to select an prioritization pattern from a set of two or more prioritization patterns based on the determined value of the traffic or demand related metric for the first observation window, wherein each prioritization pattern in the set of two or more prioritization patterns is associated to a different value of the traffic or demand related metric and each prioritization pattern in the set of two or more prioritization patterns defines a pattern of first timeslots in which the first RAT is prioritized and second timeslots in which the second RAT is prioritized. The processing circuitry is further configured to cause the network node to perform radio resource allocation for the first scheduler for the first RAT and the second scheduler for the second RAT based on the selected prioritization pattern.

Embodiments of a non-transitory computer-readable medium are also disclosed. In one embodiment, a non-transitory computer-readable medium comprising instructions for execution by processing circuitry of a network node for UE-aware radio resource allocation for DSS between a first scheduler for a first RAT and a second scheduler for a second RAT is provided, whereby the processing circuitry causes the network node to: determine, for a first observation window comprising a first plurality of timeslots, a value of a traffic or demand related metric based on scheduling requests received from the first scheduler for the first RAT during the first observation window and scheduling requests received from the second scheduler for the second RAT during the first observation window; select an prioritization pattern from a set of two or more prioritization patterns based on the determined value of the traffic or demand related metric for the first observation window, wherein each prioritization pattern in the set of two or more prioritization patterns is associated to a different value of the traffic or demand related metric and each prioritization pattern in the set of two or more prioritization patterns defines a pattern of first timeslots in which the first RAT is prioritized and second timeslots in which the second RAT is prioritized; and perform radio resource allocation for the first scheduler for the first RAT and the second scheduler for the second RAT based on the selected prioritization pattern.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system in which embodiments of the present disclosure may be implemented;

FIG. 2 illustrates the operation of a shared resource allocator for Dynamic Spectrum Sharing (DSS) radio resource allocation in which the shared resource allocator allocates radio resources to a Long Term Evolution (LTE) scheduler and a New Radio (NR) scheduler in a timeslot based on a corresponding timeslot in a dynamically selected prioritization pattern in accordance with an embodiment of the present disclosure;

FIG. 3 illustrates two example prioritization patterns;

FIGS. 4A and 4B illustrate a procedure performed by the shared resource allocator for User Equipment (UE)-aware DSS radio resource allocation in accordance with one embodiment of the present disclosure;

FIG. 5 illustrates one example embodiment of the probabilistic selection scheme of step 412-B of FIG. 4B;

FIG. 6 illustrates an example of a roulette wheel used for a probabilistic resource allocation scheme in accordance with one example embodiment of the present disclosure;

FIG. 7 illustrates example simulation results;

FIG. 8 illustrates one example embodiment of an Open Radio Access Network (O-RAN) architecture in which embodiments of the UE-aware resource allocation scheme disclosed herein may be implemented;

FIGS. 9 and 10 are schematic block diagrams of example embodiments of a network node in which the shared resource allocator of the present disclosure may be implemented;

FIG. 11 illustrates a telecommunication network connected via an intermediate network to a host computer in accordance with some embodiments of the present disclosure;

FIG. 12 is a generalized block diagram of a host computer communicating via a base station with a UE over a partially wireless connection in accordance with some embodiments of the present disclosure;

FIG. 13 is a flowchart illustrating a method implemented in a communication system in accordance with one embodiment of the present disclosure;

FIG. 14 is a flowchart illustrating a method implemented in a communication system in accordance with one embodiment of the present disclosure;

FIG. 15 is a flowchart illustrating a method implemented in a communication system in accordance with one embodiment of the present disclosure; and

FIG. 16 is a flowchart illustrating a method implemented in a communication system in accordance with one embodiment of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a 3^{rd} Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

An existing resource allocation solution for Dynamic Spectrum Sharing (DSS) allows RAT-based resource allocation rather than UE-based resource allocation.

### Example 1

Suppose UE traffic is full buffer (e.g., unlimited amount of data in the UE's data buffer) of equal priority and there are 1 LTE UE and 2 NR UEs, namely:
   LTE UE 0,
   NR UE 1, and
   NR UE 2.
With a RAT-based resource allocation solution, the resource allocation assignment could, for example, be as follows:
   LTE UE 0 is assigned timeslot 0, NR UE 1 is assigned timeslot 1, LTE UE 0 is assigned timeslot 2, NR UE 2 is assigned timeslot 3, LTE UE 0 is assigned timeslot 4, NR UE 1 is assigned timeslot 5, LTE UE 0 is assigned timeslot 6, NR UE 2 is assigned timeslot 7, etc.
   The resource allocation outcomes are the following:
      LTE UE 0 is allocated twice the amount radio resources as NR UE 1 or NR UE 2, even though the per-RAT resource allocation is roughly the same.
      On average, the delay performance of LTE UE 0 is 2 milliseconds (ms) while that of NR UE 1 or NR UE 2 is 4 ms.
      In short, the RAT-based, or RAT-fair, solution introduces a bias towards the LTE UE, since there are more UEs in the NR network than in the LTE network in this DSS cell.
With a UE-aware resource allocation solution, the resource allocation assignment could, for example, be as follows:
   LTE UE 0, NR UE 1, NR UE 2, LTE UE 0, NR UE 1, NR UE 2, LTE UE 0, NR UE 1, NR UE 2, etc.
   The resource allocation outcomes are the following:
      Each UE gets roughly the same radio resources (e.g., 33% of the radio resources), where the radio resources are divided equally among the UEs of the same priority.
      On average, the delay performance of LTE UE 0, NR UE 1 or NR UE 2 is 3 ms, which is proportional to the number of UEs of the same priority.

### Example 2

Suppose the UE traffic is full buffer of equal priority and there are 1 LTE UE and 4 NR UEs, namely:
   LTE UE 0,
   NR UE 1,
   NR UE 2,
   NR UE 3, and
   NR UE 4.
With the existing RAT-based resource allocation solution, the resource allocation assignment could, for example, be as follows:
   LTE UE 0, NR UE 1, LTE UE 0, NR UE 2, LTE UE 0, NR UE 3, LTE UE 0, NR UE 4, LTE UE 0, NR UE 1, LTE UE 0, NR UE 2, LTE UE 0, NR UE 3, LTE UE 0, NR UE 4, etc.
   The resource allocation outcomes are the following:
      LTE UE 0 gets four times the radio resources than any of the NR UEs, even though the per-RAT resource allocation is roughly the same.
      On average, the delay performance of LTE UE 0 is 2 ms while that of NR UE 1, NR UE 2, NR UE 3 or NR UE 4 is 8 ms.
      The effect of the resource allocation bias becomes prominent when the difference in the number of UEs in each RAT is large.
With a UE-aware resource allocation solution, an example resource allocation assignment could be as follows:
   LTE UE 0, NR UE 1, NR UE 2, NR UE 3, NR UE 4, LTE UE 0, NR UE 1, NR UE 2, NR UE 3, NR UE 4, etc.
   The resource allocation outcomes are the following:
      Each UE gets roughly the same radio resources (e.g., 20% of the radio resources), where the radio resources are divided equally among the UEs of the same priority.
      On average, the delay performance of each UE is 5 ms, which is proportional to the number of UEs of the same priority.

Therefore, UE-aware resource allocation in DSS ensures per-UE Quality of Service (QoS) satisfaction regardless of RATs. The impact of UE-aware resource allocation becomes prominent when the number of UEs becomes large.

To successfully transmit NR PUSCH at time T, NR PDCCH for uplink needs to be successfully transmitted at time T-K2, where K2 is the time difference between PDCCH transmission time and PUSCH transmission time. In DSS, where both LTE and NR compete for radio resources simultaneously in the frequency domain, NR PDCCH would normally need to compete with LTE PDCCH and/or LTE PDSCH. Without any proper resource allocation in advance (K2 slots in advance to be exact), over the air radio resources that could be assigned to NR PUSCH at time T would be wasted due to the lack of a successful NR PDCCH at time T-K2. The need of resource allocation coordination between NR PDCCH and NR PUSCH can be achieved via pattern-based resource allocation. Therefore, embodiments of the present disclosure relate to systems and methods that provide UE-aware resource allocation by extending pattern-based resource allocation and, by using proper prioritization patterns, the resource allocation can be achieved without degrading NR uplink performance.

Systems and methods are disclosed herein that provide a solution to the aforementioned and/or other challenges. In one embodiment, UE-aware resource allocation is provided for DSS by utilizing multiple RAT-based resource prioritization patterns. An prioritization pattern used for resource allocation is selected dynamically from a set of prioritization patterns based on estimated traffic demands in a first RAT (e.g., LTE) sharing the spectrum and a second RAT (e.g., NR) sharing the spectrum. In the example embodiments described herein, the set of prioritization patterns is a predefined set; however, the set of prioritization patterns is not limited to be predefined. In one embodiment, the dynamic selection of the prioritization pattern based on the estimated traffic demands is such that radio resources are allocated to UEs (e.g., UEs of the same priority) in the different RATs equally or at least approximately equally. In this manner, radio resource allocation is provided in a manner that aims at providing equal QoS satisfaction regardless of the RAT. In one embodiment, priority-fair resource allocation is realized by incorporating a traffic priority into UE scheduling requests in traffic demand estimation.

Note that, as used herein, “UE-aware resource allocation” is a resource allocation scheme that considers the number of UEs in the system, a number of data radio bearers (DRBs) of UEs in the system, an amount of data in the buffer for each DRB of each UE in the system, radio conditions of UEs in the system, QoS parameters for each DRB of each UE in the system, UE scheduling opportunities, or the like.

Embodiments of the solution described herein may provide a number of advantages over existing technology. For example, by using proper prioritization patterns, embodiments of the present disclosure achieve UE-aware radio resource allocation without impacting NR uplink performance. In some embodiments, the proposed solution can incorporate different traffic priorities of UEs to achieve QoS differentiation.

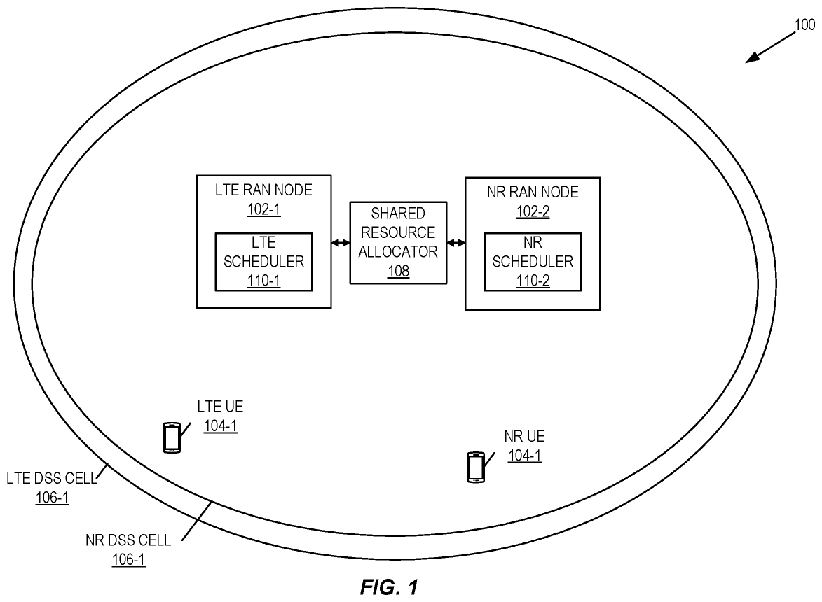

FIG. 1 illustrates one example of a cellular communications system 100 in which embodiments of the present disclosure may be implemented. In the embodiments described herein, the cellular communications system 100 includes both an LTE RAN node 102-1 serving LTE UE(s) 104-1 in an LTE DSS cell 106-1 and a NR RAN node 102-2 serving NR UE(s) 104-2 in an NR DSS cell 106-2. The LTE DSS cell 106-1 and the NR DSS cell 106-2 share the same spectrum in accordance with a DSS scheme. The LTE DSS cell 106-1 and the NR DSS cell 106-2 form a DSS cell pair that uses shared spectrum (i.e., the same carrier). In an alternative embodiment, a single DSS cell may shared resources for both LTE and NR. The description herein focuses on the former implementation but the embodiments described herein may be used for the alternative implementation where there is a single DSS cell that shares resources for both LTE and NR. A shared resource allocator 108 performs UE-aware resource allocation of radio resources for the LTE RAT and the NR RAT (i.e., for the LTE DSS cell 106-1 and the NR DSS cell 106-2). Decisions made by the shared resource allocator 108 are provided to an LTE scheduler 110-1 of the LTE RAN node 102-1 and an NR scheduler 110-2 of the NR RAN node 102-2. Details regarding the operation of the shared resource allocator 108 are provided below. However, in general, the shared resource allocator 108 performs UE-aware radio resource allocation based on LTE traffic demands (i.e., traffic demands in the LTE DSS cell 104-1) and NR traffic demands (e.g., traffic demands in the NR DSS cell 104-2). In one embodiment, the UE-aware resource allocation is performed by dynamically selecting an prioritization pattern for RAT prioritization based on the traffic demands, where this dynamic selection of the prioritization pattern for RAT prioritization aims to provide equal radio resource allocations to UEs (e.g., UEs having the same priority) in the different RATs. Note that the prioritization patterns may be the same or different for uplink and downlink directions.

Note that while illustrated separately in FIG. 1, the LTE RAN node 102-1 and the NR RAN node 102-2 may be implemented as separate physical network nodes or implemented in a single physical network node. Further, while LTE and NR are used in the example embodiments described herein, the present disclosure is not limited thereto. The UE-aware radio resource allocation described herein may be used in any DSS system to allocate resources to two (or more) RATs that share the same spectrum.

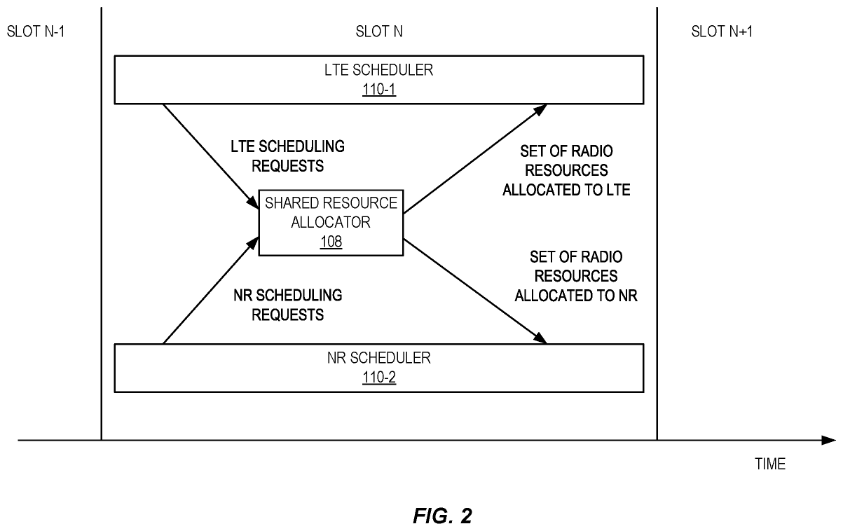

FIG. 2 illustrates the operation of the shared resource allocator 108 to allocate radio resources to the LTE scheduler 110-1 and the NR scheduler 110-2 in an n-th timeslot based on a corresponding timeslot in a dynamically selected prioritization pattern in accordance with an embodiment of the present disclosure. The shared resource allocator 108 performs UE-aware radio resource allocation between LTE and NR by dynamically selecting an prioritization pattern to be used for resource allocation from a predefined set of prioritization patterns based on traffic demands for LTE and NR. As used herein, an “prioritization pattern” is a pattern of prioritized RATs for a sequence of timeslots. For example, the pattern may span 10 timeslots and, for each timeslot, indicate either LTE or NR as the prioritized RAT for that timeslot. In timeslots in which NR is the prioritized RAT, the shared resource allocator 108 first selects radio resources for NR, and the remaining resources (if any) can be selected for LTE. In timeslots in which LTE is prioritized, the shared resource allocator 108 first selects radio resources for LTE, and the remaining resources (if any) can be selected for NR. The predefined set of prioritization patterns includes two or more prioritization patterns each associated to (e.g., designed for) a different value of a traffic or demand related metric (e.g., ratio of LTE demand to NR demand or vice versa, ratio of LTE demand to total LTE+NR demand, or ratio of NR demand to total LTE+NR demand, etc.). In other words, to ensure resource-fair scheduling, multiple prioritization patterns are employed, where each prioritization pattern has a different number of NR-prioritized timeslots and LTE-prioritized timeslots, tailoring for different numbers of UEs in each RAT. The prioritization patterns are preferably designed to take into account NR channel coordination between NR PDCCH and NR PUSCH.

The traffic or demand related metric may be, e.g., a ratio of LTE demand to NR demand, a ratio of NR demand to LTE demand, a ratio of LTE demand to total LTE plus NR demand, or ratio of NR demand to total LTE plus NR demand, as described below. However, the traffic or demand related metric is not limited thereto. For example, the traffic or demand related metric may alternatively be relative priority of LTE traffic relative ot NR traffic or vice versa, buffer size for LTE traffic (e.g., across all LTE UEs) relative to buffer size for NR traffic (e.g., across all NR UEs) or vice versa, number of LTE UEs relative to the number of NR UEs or vice versa, or any combination thereof.

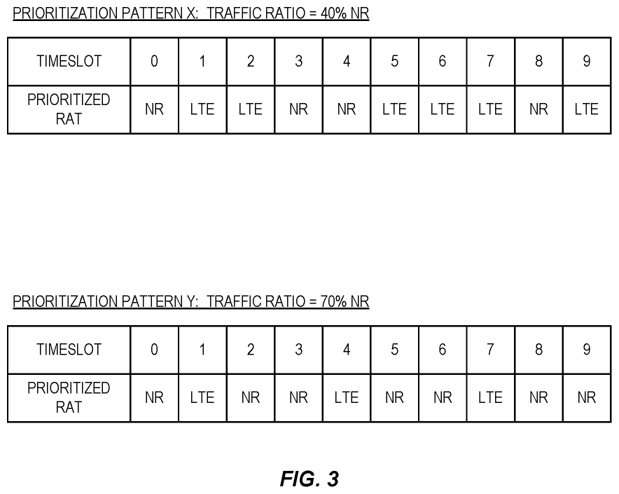

FIG. 3 illustrates two example prioritization patterns. The first prioritization pattern is associated to (e.g., designed for) a traffic demand ratio of 40% NR traffic such that NR is the prioritized RAT in 40% of the timeslots in the prioritization pattern. The second example prioritization pattern is associated to (e.g., desired for) a traffic demand ratio of 70% NR traffic such that NR is the prioritized RAT in 70% of the timeslots in the prioritization pattern. In these examples, the length, or period, of each of the prioritization patterns is 10 timeslots.

Based on the actual traffic demands for LTE and NR, the shared resource allocator 108 dynamically selects an prioritization pattern to be used for radio resource allocation from the predefined set of prioritization patterns. In one embodiment, prioritization pattern selection is a function of estimated UE traffic demands for LTE and NR over an observation window. For instance, if NR traffic has been dominant, a prioritization pattern selected by the shared resource allocator 108 is one that has more NR-prioritized timeslots.

When performing resource allocation based on an prioritization pattern, for each timeslot, the shared resource allocator 108 first allocates radio resources to the RAT that is prioritized for the timeslot in the prioritization pattern. If any radio resources remain after allocating radio resources for the prioritized RAT, the shared resource allocator 108 may then allocate radio resources for the non-prioritized RAT from among the remaining radio resources.

More specifically, as illustrated in FIG. 2, for each timeslot, the shared resource allocator 108 receives scheduling requests for a timeslot from both the LTE scheduler 110-1 and the NR scheduler 110-2. As discussed below in detail, the scheduling requests are used by the shared resource allocator 108 to determine a value of a traffic or demand related metric (e.g., traffic ratio) indicative of the traffic demand for LTE relative to that of NR, or vice versa, for the timeslot. Values for this per time-slot traffic or demand related metric are obtained and stored for multiple timeslots in an observation window (e.g., W timeslots where W>1 and preferably W is greater than a length of a prioritization pattern), and the values of the per-timeslot traffic related metric over the observation window are combined (e.g., averaged) to provide a combined (e.g., averaged) value for the traffic or demand related metric for the observation window. The shared resource allocator 108 uses this combined value for the traffic or demand related metric for the observation window to select, from the set of predefined prioritization patterns, an prioritization pattern to be used for resource allocation in the timeslots of the next observation window. Further, for each timeslot, the shared resource allocator 108 first allocates radio resources to the prioritized RAT (i.e., LTE or NR in this example) for this timeslot in the selected prioritization pattern for the current observation window. Further, if any radio resources are remaining in the timeslot after allocating radio resources to the prioritized RAT, the shared resource allocator 108 then allocates, from any remaining radio resources in the timeslot, radio resources for the non-prioritized RAT for this timeslot in the selected prioritization pattern for the current observation window. The radio resource allocation decisions are then provided to the LTE scheduler 110-1 and the NR scheduler 110-2.

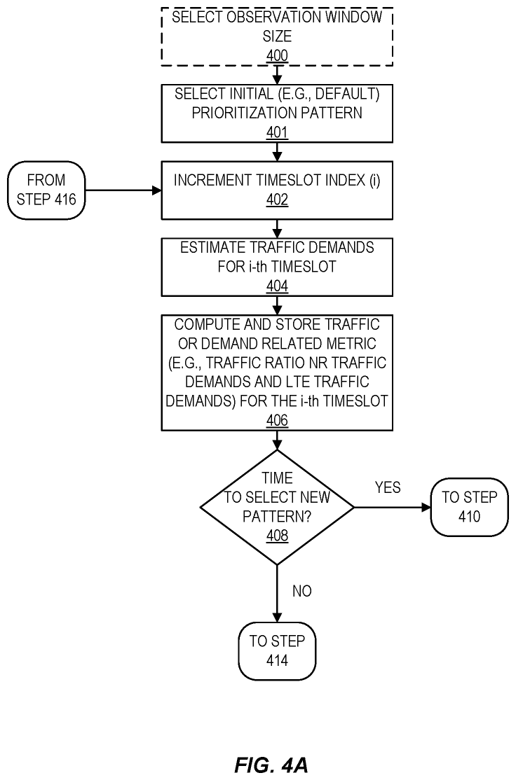

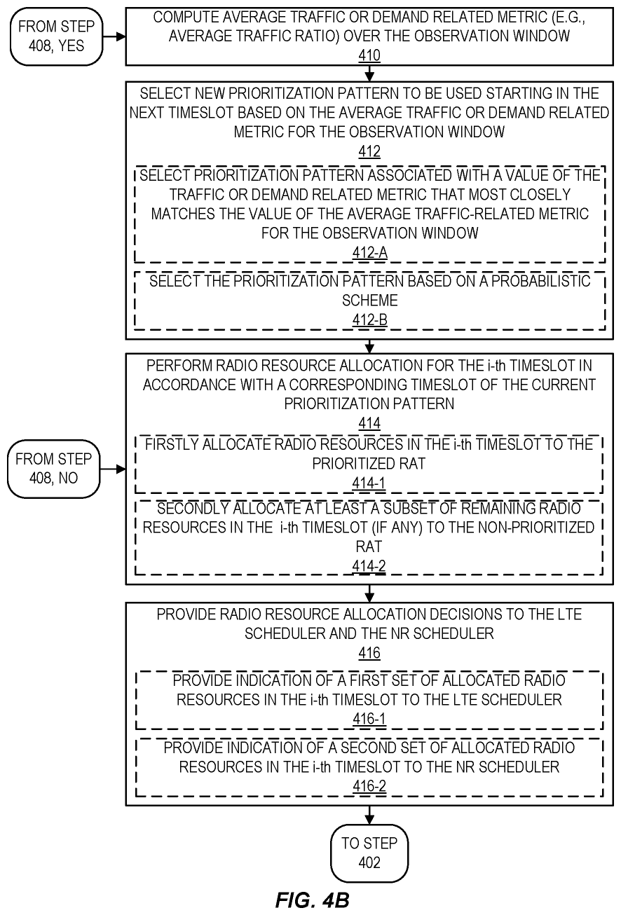

FIGS. 4A and 4B illustrate a procedure performed by the shared resource allocator 108 in accordance with one embodiment of the present disclosure. Optional steps are represented by dashed lines/boxes. Further, while LTE and NR are used as an example, the procedure may be utilized for resource allocation for any two (or more) RATs. As illustrated, an observation window size is selected (step 400). In general, the observation window size is a compromise between obtaining a better traffic or demand related metric for prioritization pattern selection and responsiveness of the shared resource allocator 108 to changes in traffic demands between LTE and NR. In one example embodiment, the observation window size is equal to or greater than the length of a prioritization pattern (e.g., an integer multiple of a length of a prioritization pattern). An optimal observation window size may, for example, be determined via simulations.

The shared resource allocator 108 selects an initial prioritization pattern to be used for the initial observation window (step 401). The initial prioritization pattern may be, e.g., a default prioritization pattern, which may or may not be one of the predefined set of prioritization patterns.

At this point, a timeslot index (i) is incremented (step 402). The shared resource allocator 108 estimates traffic demands for LTE and NR for the i-th timeslot (404). In one embodiment, the shared resource allocator 108 determines a traffic demand for LTE based on the number of radio resources (e.g., Physical Resource Blocks (PRBs)) in the i-th timeslot needed to satisfy LTE scheduling requests received from the LTE scheduler 110-1 for the i-th timeslot. In one embodiment, the traffic demand for LTE is the number of PRBs needed to satisfy the LTE scheduling requests received from the LTE scheduler 110-1 for the i-th timeslot. In another embodiment, LTE UEs 104-1 and/or LTE traffic are associated with priorities, and the LTE scheduling requests are weighted based on the priority of the associated LTE UE 104-1 and/or the associated traffic. With different UE or traffic priorities, the shared resource allocator 108 proportionally arbitrates resources according to the relative traffic priorities of the scheduling requests. For instance, the higher the relative priority of the NR scheduling request, the larger the estimated NR traffic demand and hence the more likely an prioritization pattern that has more NR prioritized timeslots will be selected. For example, if there are three priorities, namely, high, medium, and low, the traffic demand may be calculated as w_{High}N_{High}+w_{Medium}N_{Medium}+w_{Low}N_{Low}, where w_{High} is the weight assigned to high priority UEs or traffic, w_{Medium} is the weight assigned to medium priority UEs or traffic, w_{Low} is the weight assigned to low priority UEs or traffic, N_{High} is the number of PRBs needed to satisfy scheduling requests received for high priority UEs or traffic, N_{Medium} is the number of PRBs needed to satisfy scheduling requests received for medium priority UEs or traffic, and N_{Low} is the number of PRBs needed to satisfy scheduling requests received for low priority UEs or traffic. The traffic demand for NR may be estimated for the i-th timeslot in a similar manner.

The shared resource allocator 108 computes and stores a value for a traffic or demand related metric for the i-th timeslot (step 406). In one embodiment, the traffic or demand related metric is a traffic demand ratio for the two RATs (e.g., a ratio of NR demand to LTE demand or a ratio of LTE demand to NR demand or a ratio of NR demand to total LTE plus NR demand or ratio of LTE demand to total LTE plus NR demand) for the i-th timeslot. The shared resource allocator 108 determines whether it is time to select a next prioritization pattern (step 408). In one embodiment, a new prioritization pattern is selected at the end of the current prioritization pattern, and, as such, the shared resource allocator 108 whether the i-th timeslot is the end of the current prioritization pattern. If not, the process proceeds to step 414.

If the shared resource allocator 108 determines that it is time to select a new prioritization pattern (e.g., if the i-th timeslot is the end of the current prioritization pattern), the shared resource allocator 108 computes a combined value of the traffic or demand related metric for the observation window (step 410). Here, the observation window is a window of the selected observation window size from step 400 ending at the i-th timeslot. So, if the observation window has a size of W timeslots, then the observation window is a set of W consecutive timeslots ending at the i-th timeslot. Further, if W is greater than the length of a prioritization pattern, then the observation windows used for two (or more) consecutive prioritization pattern selections will overlap. In the illustrated example embodiment, the combined value computed in step 410 is an average value of the traffic or demand related metric for the observation window (i.e., the average of the values of the traffic or demand related metric computed and stored for the timeslots in the observation window). The shared resource allocator 108 then selects an new prioritization pattern to be used by the shared resource allocator 108 from the predefined set of prioritization patterns based on the computed average value of the traffic or demand related metric for the observation window (step 412). The selected new prioritization pattern is to be used starting in the next timeslot (timeslot i+1).

In one embodiment, the shared resource allocator 108 selects one of the predefined set of prioritization patterns associated to a value of the traffic or demand related metric that most closely matches the computed average value of the traffic or demand related metric for the observation window as the new prioritization pattern to be used starting at the next timeslot (step 412-A). Note that, if computational complexity is not a concern, the predefined set of prioritization patterns may include many prioritization patterns, where each prioritization pattern targets a specific value of the traffic or demand related metric (e.g., a specific ratio of NR demands versus LTE demands). However, in practice, to keep computational complexity low, the number of prioritization patterns is preferably small (e.g., greater than or equal to 2 and less than, e.g., 10), where a decision error due to coarse granularity in pattern selection is inevitable. For example, assume that there are five prioritization patterns in the predefined set, where the prioritization patterns target the following traffic demand ratios:
Pattern_0: 0% NR traffic, where 0% NR traffic and 100% LTE traffic is expected in an observation window;
Pattern_25: 25% NR traffic, where 25% NR traffic and 75% LTE traffic is expected in an observation window;
Pattern_50: 50% NR traffic, where 50% NR traffic and 50% LTE traffic is expected in an observation window;
Pattern_75: 75% NR traffic, where 75% NR traffic and 25% LTE traffic is expected in an observation window; and
Pattern_100: 100% NR traffic, where 100% NR traffic and 0% LTE traffic is expected in an observation window.

In the case of 1 LTE UE and 2 NR UEs, an actual averaged traffic demand ratio is 66.67%, selecting the prioritization pattern based on the closest metric will always select Pattern_75, thereby over-dimensioning the NR traffic while under-dimensioning the LTE traffic in the long run.

One approach to reduce the decision error is to increase the number of prioritization patterns in the predefined set to reduce the amount of decision errors at the cost of computational and storage complexity. For instance, 101 prioritization patterns can be defined (e.g., Pattern_0, Pattern_1, Pattern_2, . . . , Pattern_100).

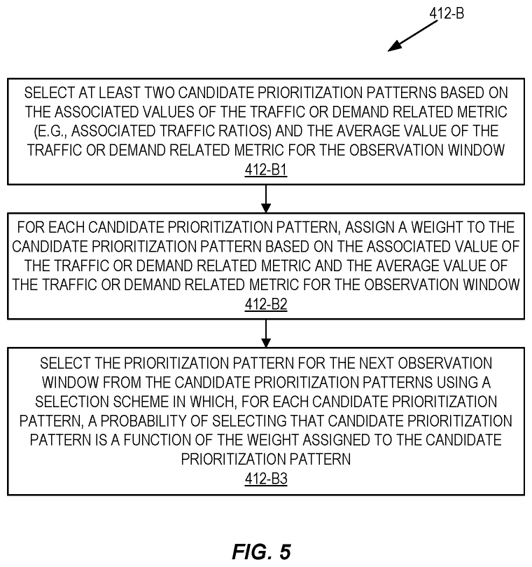

Another approach for reducing the decision error is to employ probabilistic prioritization pattern selection. Thus, as an alternative to step 412-A, the shared resource allocator 108 selects the new prioritization pattern to be used from the predefined set of prioritization patterns using a probabilistic selection scheme (step 412-B). FIG. 5 illustrates one example embodiment of the probabilistic selection scheme of step 412-B. As illustrated in FIG. 5, the shared resource allocator 108 selects two or more candidate prioritization patterns from the predefined set of prioritization patterns (step 412-B1). The selected candidate prioritization patterns may be, for example, the two prioritization patterns having associated values for the traffic or demand related metric that most closely match the average value of the traffic or demand related metric for the observation window. Alternatively, the candidate prioritization patterns are all of the prioritization patterns in the predefined set. The shared resource allocator 108 assigns each candidate prioritization pattern a probability that is a function of the associated value of the traffic or demand related metric (e.g., traffic ratio) and the combined (e.g., averaged) value of the traffic or demand related metric for the observation window (step 412-B2). The closer the associated value is to the combined value for the observation window, the higher the probability that the (candidate) prioritization pattern is selected as the new prioritization pattern. The shared resource allocator 108 then selects the new prioritization pattern to be used according to the probabilistic selection (step 412-B3). In other words, the shared resource allocator 108 selects the new prioritization pattern to be used from the candidate prioritization patterns using a selection scheme in which, for each candidate prioritization pattern, the probability of that candidate prioritization pattern being selected is a function of the weight assigned to that candidate prioritization pattern in step 412-B2.

One example of a low-complexity probabilistic selection process is as follows:
Suppose an averaged traffic demand ratio, denoted by \tilde{x} of NR demands and LTE demands is 0.40.
For each prioritization pattern, compute the difference between its associated (i.e., target) ratio and the averaged traffic demand ratio:
   Pattern_0: abs(0−\tilde{x})=abs(0−0.4)=0.4
   Pattern_25: abs(0.25−\tilde{x})=0.15
   Pattern_50: abs(0.50−\tilde{x})=0.1
   Pattern_75: abs(0.75−\tilde{x})=0.35
   Pattern_100: abs(1−\tilde{x})=0.6
Select the closest two prioritization patterns as candidate prioritization patterns and compute the sum of the differences: sum=0.15+0.1=0.25
Assign a weight to each of the two candidate prioritization patterns:
   Pattern_25:

$$( 1 - \frac{0.15}{0.25} ) = 0.4$$

Pattern_50:

$$( 1 - \frac{0.1}{0.25} ) = 0.6$$

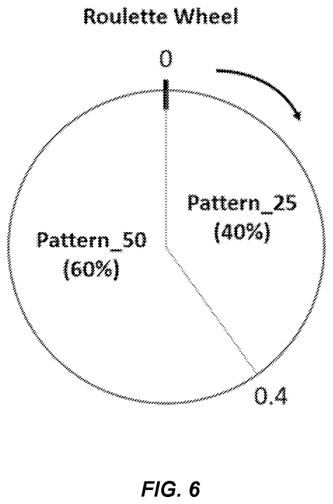

Calculate and assign a normalized weight to each of the candidate prioritization patterns as a probability of being selected:
   P(Pattern_25): 0.4/1.0=0.4
   P(Pattern_50): 0.6/1.0=0.6
Create a roulette wheel for probabilistic selection (see FIG. 6):
   Pattern_25 covers the range of (0, 0.4)
   Pattern_50 covers the range of [0.4, 1)
Generate a random number between 0 and 1, and select the candidate prioritization pattern where the random number lands.

Note that, with full buffer traffic, traffic demands from NR and LTE can be estimated for every timeslot. In practice with bursty traffic, there could be zero traffic demands for a period of time. With zero traffic demands over the observation window, no traffic demand ratio can be computed. In this case:
In one embodiment, if there is no traffic demand over the timeslots in the observation window, the shared resource allocator 108 selects the default prioritization pattern as the new prioritization pattern to be used.
If the NR traffic has been dominant in a customer network, the default prioritization pattern may be configured to be an prioritization pattern that has more NR prioritized slots.
If there is no bias in either NR traffic or LTE traffic, the default prioritization pattern can, for example, be set to 50%, where half of the slots are NR prioritized slots and the other half are LTE prioritized slots.

Returning to FIG. 4B, whether proceeding from step 408 (NO branch) or from step 412, the shared resource allocator 108 performs radio resource allocation for the i-th timeslot in accordance with a corresponding timeslot for the current prioritization pattern (step 412). More specifically, the prioritization pattern indicates, for the i-th timeslot, whether LTE or NR is to be prioritized and the shared resource allocator 108 allocates the radio resources in the i-th timeslot accordingly. In one embodiment, the shared resource allocator 108 firstly allocates radio resources in the i-th timeslot for the prioritized RAT (either LTE or NR as indicated by the prioritization pattern) (step 414-1). After allocating radio resources in the i-th timeslot for the prioritized RAT, if any radio resources are remaining in the i-th timeslot, the shared resource allocator 108 allocates radio resources from the remaining radio resources in the i-th timeslot to the non-prioritized RAT (step 414-2).

The shared resource allocator 108 provides radio resource allocation decisions for the i-th timeslot to the LTE scheduler 110-1 and the NR scheduler 110-2 (step 416). More specifically, in one embodiment, the shared resource allocator 108 provides an indication of a first set of radio resources in the i-th timeslot allocated to LTE (in step 414) to the LTE scheduler 110-1 (step 416-1) and provides an indication of a second set of radio resources in the i-th timeslot allocated to NR (in step 414) to the NR scheduler 110-2 (step 416-2).

The process then returns to step 402 and is repeated for the next timeslot.

System-level simulations have been conducted to illustrate the benefits of one example embodiment of the present disclosure. The details of the simulation settings are as follows:
Setup:
   20 MHz Frequency Division Duplex (FDD) Cell with LTE and NR (i.e., 20 MHz LTE DSS cell and 20 MHz NR DSS cell using DSS to share the same 20 MHz carrier)
   1 LTE UE: UE #0
   2 NR UEs: UE #1 and UE #2
   Full buffer traffic
   Traffic priority of NR scheduling requests=1.3
   Traffic priority of LTE scheduling requests=1
Resource Allocation Schemes Simulated:
   Proposed UE-aware resource allocation
   Fair RAT-based resource allocation as a baseline resource allocation
Key Performance Indicator (KPI):
   Over-the-air (OTA) allocated resources
Expected Results:
   The ratio of the number of resources assigned to an NR UE (either UE #1 or UE #2) and the number of resources assigned to an LTE UE (UE #0) is close to 1.3.
   For NR UEs, the number of resources assigned to UE #1 is more or less the same as the number of resources assigned to a UE #2.

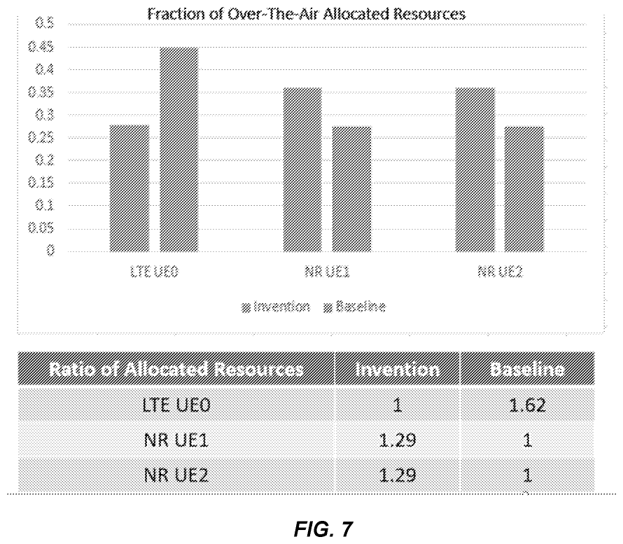

The results of the simulation are illustrated in FIG. 7. As illustrated, the proposed UE-aware resource allocation results in a ratio of over-the-air allocated resources between an NR UE and an LTE UE close to 1.3. The ratio of allocated resources between two NR UEs is close to 1. In contrast, the baseline RAT-based resource allocation results in an allocation of over-the-air resources in a manner that is not proportionally shared among the three UEs and, as such, cannot be considered as a UE-aware resource allocation.

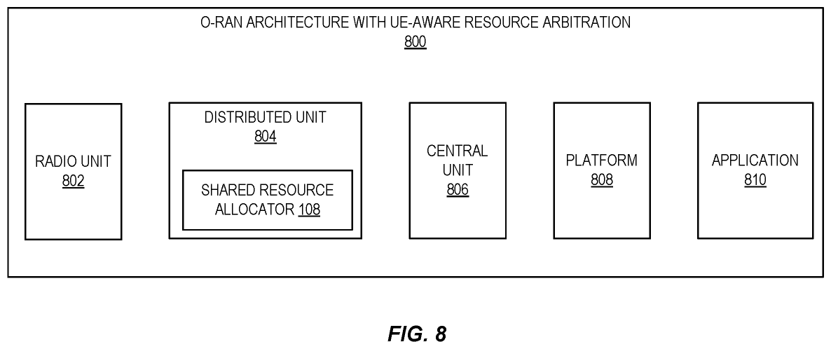

Note that, in one embodiment, the UE-aware resource allocation solution according to any of the embodiments described herein, may be implemented in an Open RAN (O-RAN) system. In this embodiment, the shared resource allocator 108 resides in a Distributed Unit(s) (DUs) (e.g., gNB-DU(s)) since this resource allocation belongs to Medium Access Control (MAC)-layer resource allocation. An example is illustrated in FIG. 8. As shown, an O-RAN architecture 800 includes a radio unit 802, a distributed unit 804 that includes the shared resource allocator 108, a central unit 806, a platform 808, and an application(s) 810.

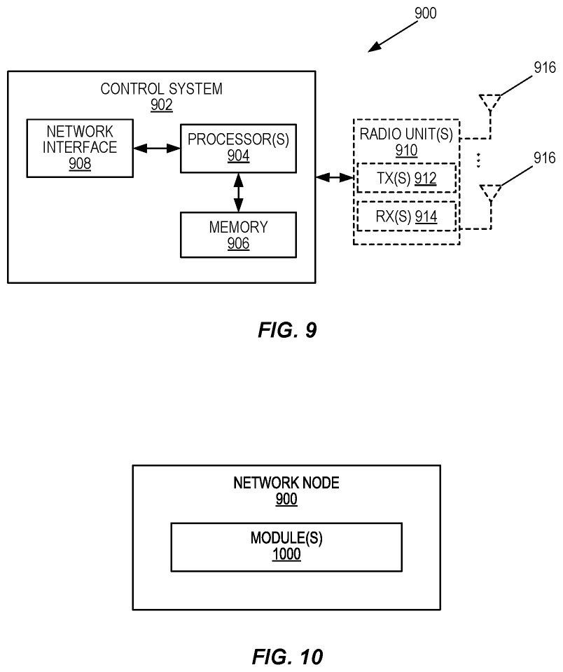

FIG. 9 is a schematic block diagram of a network node 900 according to some embodiments of the present disclosure. Optional features are represented by dashed boxes. The network node 900 is a network node that includes or implements the shared resource allocator 108. The network node 900 may be, for example, a base station (e.g., gNB or combined gNB/eNB) or a network node that implements all or part of the functionality of a base station (e.g., a gNB-DU or a combined DU for a combined gNB/eNB), or the like. As illustrated, the network node 900 includes a control system 902 that includes one or more processors 904 (e.g., Central Processing Units (CPUs), Application Specific Integrated Circuits (ASICs), Field Programmable Gate Arrays (FPGAs), and/or the like), memory 906, and a network interface 908. The one or more processors 904 are also referred to herein as processing circuitry. In addition, if the network node 900 is a radio access node (e.g., a base station or network node that implements at least some of the functionality of the base station), the network node 900 may include one or more radio units 910 that each includes one or more transmitters 912 and one or more receivers 914 coupled to one or more antennas 916. The radio units 910 may be referred to or be part of radio interface circuitry. In some embodiments, the radio unit(s) 910 is external to the control system 902 and connected to the control system 902 via, e.g., a wired connection (e.g., an optical cable). However, in some other embodiments, the radio unit(s) 910 and potentially the antenna(s) 916 are integrated together with the control system 902. In one embodiment, the one or more processors 904 operate to provide one or more functions of the shared resource allocator 108 as described herein. In some embodiments, the function(s) are implemented in software that is stored, e.g., in the memory 906 and executed by the one or more processors 904.

FIG. 10 is a schematic block diagram of the network node 900 according to some other embodiments of the present disclosure. The network node 900 includes one or more modules 1000, each of which is implemented in software. The module(s) 1000 provide the functionality of the shared resource allocator 108 as described herein.

In some embodiments, a computer program including instructions which, when executed by at least one processor, causes the at least one processor to carry out the functionality of the shared resource allocator 108 as described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

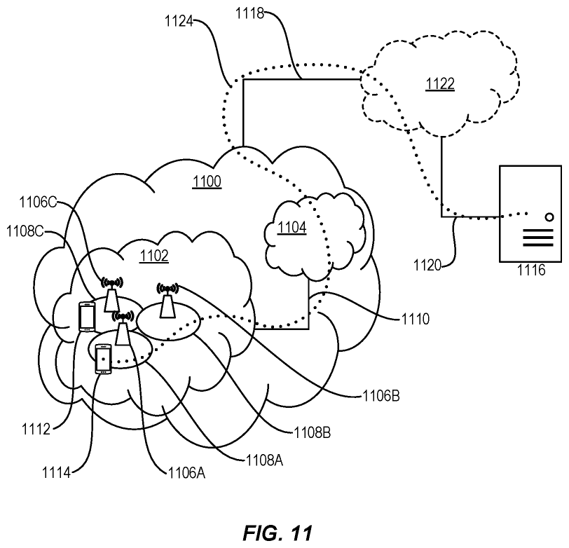

With reference to FIG. 11, in accordance with an embodiment, a communication system includes a telecommunication network 1100, such as a 3GPP-type cellular network, which comprises an access network 1102, such as a RAN, and a core network 1104. The access network 1102 comprises a plurality of base stations 1106A, 1106B, 1106C, such as Node Bs, eNBs, gNBs, or other types of wireless Access Points (APs), each defining a corresponding coverage area 1108A, 1108B, 1108C. Each base station 1106A, 1106B, 1106C is connectable to the core network 1104 over a wired or wireless connection 1110. A first UE 1112 located in coverage area 1108C is configured to wirelessly connect to, or be paged by, the corresponding base station 1106C. A second UE 1114 in coverage area 1108A is wirelessly connectable to the corresponding base station 1106A. While a plurality of UEs 1112, 1114 are illustrated in this example, the disclosed embodiments are equally applicable to a situation where a sole UE is in the coverage area or where a sole UE is connecting to the corresponding base station 1106.

The telecommunication network 1100 is itself connected to a host computer 1116, which may be embodied in the hardware and/or software of a standalone server, a cloud-implemented server, a distributed server, or as processing resources in a server farm. The host computer 1116 may be under the ownership or control of a service provider, or may be operated by the service provider or on behalf of the service provider. Connections 1118 and 1120 between the telecommunication network 1100 and the host computer 1116 may extend directly from the core network 1104 to the host computer 1116 or may go via an optional intermediate network 1122. The intermediate network 1122 may be one of, or a combination of more than one of, a public, private, or hosted network; the intermediate network 1122, if any, may be a backbone network or the Internet; in particular, the intermediate network 1122 may comprise two or more sub-networks (not shown).

The communication system of FIG. 11 as a whole enables connectivity between the connected UEs 1112, 1114 and the host computer 1116. The connectivity may be described as an Over-the-Top (OTT) connection 1124. The host computer 1116 and the connected UEs 1112, 1114 are configured to communicate data and/or signaling via the OTT connection 1124, using the access network 1102, the core network 1104, any intermediate network 1122, and possible further infrastructure (not shown) as intermediaries. The OTT connection 1124 may be transparent in the sense that the participating communication devices through which the OTT connection 1124 passes are unaware of routing of uplink and downlink communications. For example, the base station 1106 may not or need not be informed about the past routing of an incoming downlink communication with data originating from the host computer 1116 to be forwarded (e.g., handed over) to a connected UE 1112. Similarly, the base station 1106 need not be aware of the future routing of an outgoing uplink communication originating from the UE 1112 towards the host computer 1116.

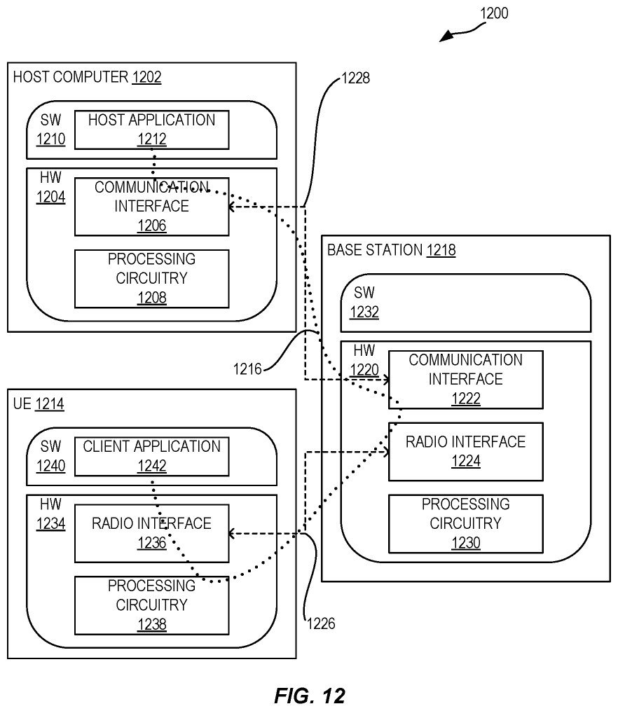

Example implementations, in accordance with an embodiment, of the UE, base station, and host computer discussed in the preceding paragraphs will now be described with reference to FIG. 12. In a communication system 1200, a host computer 1202 comprises hardware 1204 including a communication interface 1206 configured to set up and maintain a wired or wireless connection with an interface of a different communication device of the communication system 1200. The host computer 1202 further comprises processing circuitry 1208, which may have storage and/or processing capabilities. In particular, the processing circuitry 1208 may comprise one or more programmable processors, ASICs, FPGAs, or combinations of these (not shown) adapted to execute instructions. The host computer 1202 further comprises software 1210, which is stored in or accessible by the host computer 1202 and executable by the processing circuitry 1208. The software 1210 includes a host application 1212. The host application 1212 may be operable to provide a service to a remote user, such as a UE 1214 connecting via an OTT connection 1216 terminating at the UE 1214 and the host computer 1202. In providing the service to the remote user, the host application 1212 may provide user data which is transmitted using the OTT connection 1216.

The communication system 1200 further includes a base station 1218 provided in a telecommunication system and comprising hardware 1220 enabling it to communicate with the host computer 1202 and with the UE 1214. The hardware 1220 may include a communication interface 1222 for setting up and maintaining a wired or wireless connection with an interface of a different communication device of the communication system 1200, as well as a radio interface 1224 for setting up and maintaining at least a wireless connection 1226 with the UE 1214 located in a coverage area (not shown in FIG. 12) served by the base station 1218. The communication interface 1222 may be configured to facilitate a connection 1228 to the host computer 1202. The connection 1228 may be direct or it may pass through a core network (not shown in FIG. 12) of the telecommunication system and/or through one or more intermediate networks outside the telecommunication system. In the embodiment shown, the hardware 1220 of the base station 1218 further includes processing circuitry 1230, which may comprise one or more programmable processors, ASICs, FPGAS, or combinations of these (not shown) adapted to execute instructions. The base station 1218 further has software 1232 stored internally or accessible via an external connection.

The communication system 1200 further includes the UE 1214 already referred to. The UE's 1214 hardware 1234 may include a radio interface 1236 configured to set up and maintain a wireless connection 1226 with a base station serving a coverage area in which the UE 1214 is currently located. The hardware 1234 of the UE 1214 further includes processing circuitry 1238, which may comprise one or more programmable processors, ASICs, FPGAs, or combinations of these (not shown) adapted to execute instructions. The UE 1214 further comprises software 1240, which is stored in or accessible by the UE 1214 and executable by the processing circuitry 1238. The software 1240 includes a client application 1242. The client application 1242 may be operable to provide a service to a human or non-human user via the UE 1214, with the support of the host computer 1202. In the host computer 1202, the executing host application 1212 may communicate with the executing client application 1242 via the OTT connection 1216 terminating at the UE 1214 and the host computer 1202. In providing the service to the user, the client application 1242 may receive request data from the host application 1212 and provide user data in response to the request data. The OTT connection 1216 may transfer both the request data and the user data. The client application 1242 may interact with the user to generate the user data that it provides.

It is noted that the host computer 1202, the base station 1218, and the UE 1214 illustrated in FIG. 12 may be similar or identical to the host computer 1116, one of the base stations 1106A, 1106B, 1106C, and one of the UEs 1112, 1114 of FIG. 11, respectively. This is to say, the inner workings of these entities may be as shown in FIG. 12 and independently, the surrounding network topology may be that of FIG. 11.

In FIG. 12, the OTT connection 1216 has been drawn abstractly to illustrate the communication between the host computer 1202 and the UE 1214 via the base station 1218 without explicit reference to any intermediary devices and the precise routing of messages via these devices. The network infrastructure may determine the routing, which may be configured to hide from the UE 1214 or from the service provider operating the host computer 1202, or both. While the OTT connection 1216 is active, the network infrastructure may further take decisions by which it dynamically changes the routing (e.g., on the basis of load balancing consideration or reconfiguration of the network).

The wireless connection 1226 between the UE 1214 and the base station 1218 is in accordance with the teachings of the embodiments described throughout this disclosure. One or more of the various embodiments improve the performance of OTT services provided to the UE 1214 using the OTT connection 1216, in which the wireless connection 1226 forms the last segment.

A measurement procedure may be provided for the purpose of monitoring data rate, latency, and other factors on which the one or more embodiments improve. There may further be an optional network functionality for reconfiguring the OTT connection 1216 between the host computer 1202 and the UE 1214, in response to variations in the measurement results. The measurement procedure and/or the network functionality for reconfiguring the OTT connection 1216 may be implemented in the software 1210 and the hardware 1204 of the host computer 1202 or in the software 1240 and the hardware 1234 of the UE 1214, or both. In some embodiments, sensors (not shown) may be deployed in or in association with communication devices through which the OTT connection 1216 passes; the sensors may participate in the measurement procedure by supplying values of the monitored quantities exemplified above, or supplying values of other physical quantities from which the software 1210, 1240 may compute or estimate the monitored quantities. The reconfiguring of the OTT connection 1216 may include message format, retransmission settings, preferred routing, etc.; the reconfiguring need not affect the base station 1218, and it may be unknown or imperceptible to the base station 1218. Such procedures and functionalities may be known and practiced in the art. In certain embodiments, measurements may involve proprietary UE signaling facilitating the host computer's 1202 measurements of throughput, propagation times, latency, and the like. The measurements may be implemented in that the software 1210 and 1240 causes messages to be transmitted, in particular empty or ‘dummy’ messages, using the OTT connection 1216 while it monitors propagation times, errors, etc.

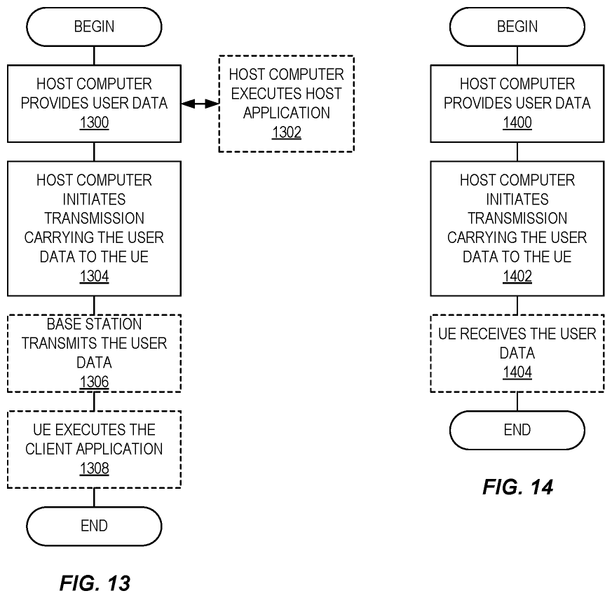

FIG. 13 is a flowchart illustrating a method implemented in a communication system, in accordance with one embodiment. The communication system includes a host computer, a base station, and a UE which may be those described with reference to FIGS. 11 and 12. For simplicity of the present disclosure, only drawing references to FIG. 13 will be included in this section. In step 1300, the host computer provides user data. In sub-step 1302 (which may be optional) of step 1300, the host computer provides the user data by executing a host application. In step 1304, the host computer initiates a transmission carrying the user data to the UE. In step 1306 (which may be optional), the base station transmits to the UE the user data which was carried in the transmission that the host computer initiated, in accordance with the teachings of the embodiments described throughout this disclosure. In step 1308 (which may also be optional), the UE executes a client application associated with the host application executed by the host computer.

FIG. 14 is a flowchart illustrating a method implemented in a communication system, in accordance with one embodiment. The communication system includes a host computer, a base station, and a UE which may be those described with reference to FIGS. 11 and 12. For simplicity of the present disclosure, only drawing references to FIG. 14 will be included in this section. In step 1400 of the method, the host computer provides user data. In an optional sub-step (not shown) the host computer provides the user data by executing a host application. In step 1402, the host computer initiates a transmission carrying the user data to the UE. The transmission may pass via the base station, in accordance with the teachings of the embodiments described throughout this disclosure. In step 1404 (which may be optional), the UE receives the user data carried in the transmission.

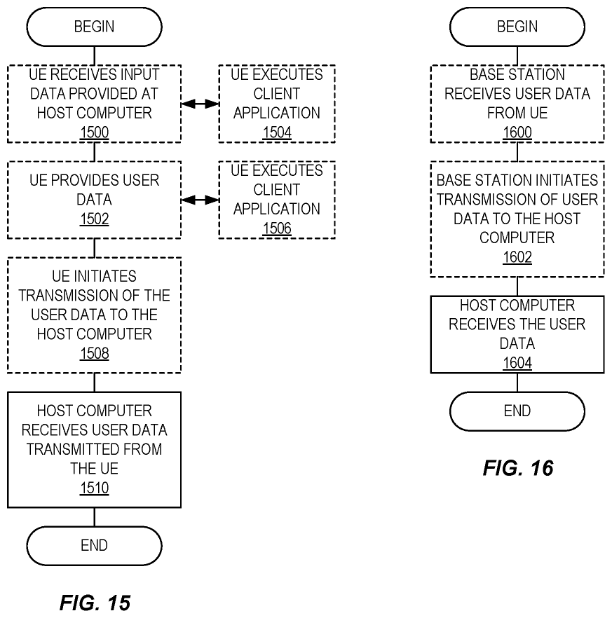

FIG. 15 is a flowchart illustrating a method implemented in a communication system, in accordance with one embodiment. The communication system includes a host computer, a base station, and a UE which may be those described with reference to FIGS. 11 and 12. For simplicity of the present disclosure, only drawing references to FIG. 15 will be included in this section. In step 1500 (which may be optional), the UE receives input data provided by the host computer. Additionally or alternatively, in step 1502, the UE provides user data. In sub-step 1504 (which may be optional) of step 1500, the UE provides the user data by executing a client application. In sub-step 1506 (which may be optional) of step 1502, the UE executes a client application which provides the user data in reaction to the received input data provided by the host computer. In providing the user data, the executed client application may further consider user input received from the user. Regardless of the specific manner in which the user data was provided, the UE initiates, in sub-step 1508 (which may be optional), transmission of the user data to the host computer. In step 1510 of the method, the host computer receives the user data transmitted from the UE, in accordance with the teachings of the embodiments described throughout this disclosure.

FIG. 16 is a flowchart illustrating a method implemented in a communication system, in accordance with one embodiment. The communication system includes a host computer, a base station, and a UE which may be those described with reference to FIGS. 11 and 12. For simplicity of the present disclosure, only drawing references to FIG. 16 will be included in this section. In step 1600 (which may be optional), in accordance with the teachings of the embodiments described throughout this disclosure, the base station receives user data from the UE. In step 1602 (which may be optional), the base station initiates transmission of the received user data to the host computer. In step 1604 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a shared resource allocator for User Equipment (UE) aware radio resource allocation for dynamic spectrum sharing between a first scheduler for a first Radio Access Technology (RAT) and a second scheduler for a second RAT, the method comprising:
determining, for a first observation window comprising a first plurality of timeslots, a value of a traffic or demand related metric based on scheduling requests received from the first scheduler for the first RAT during the first observation window and scheduling requests received from the second scheduler for the second RAT during the first observation window;
selecting a prioritization pattern from a set of two or more prioritization patterns based on the determined value of the traffic or demand related metric for the first observation window, wherein:
each prioritization pattern in the set of two or more prioritization patterns is associated to a different value of the traffic or demand related metric;
each prioritization pattern in the set of two or more prioritization patterns defines a pattern of first timeslots in which the first RAT is prioritized and second timeslots in which the second RAT is prioritized; and
performing radio resource allocation for the first scheduler for the first RAT and the second scheduler for the second RAT based on the selected prioritization pattern.

2. The method of claim 1, wherein performing radio resource allocation for the first scheduler for the first RAT and the second scheduler for the second RAT based on the selected prioritization pattern comprises, for each timeslot of a second plurality of timeslots:
firstly allocating radio resources in the timeslot to one of the first RAT and the second RAT that is prioritized in a respective timeslot of the selected prioritization pattern.

3. The method of claim 2, wherein performing radio resource allocation for the first scheduler for the first RAT and the second scheduler for the second RAT based on the selected prioritization pattern further comprises, for each timeslot of the second plurality of timeslots:
if there are any remaining radio resources in the timeslot after firstly allocating radio resources in the timeslot to the one of the first RAT and the second RAT that is prioritized in a respective timeslot of the selected prioritization pattern, secondly allocating at least a portion of the remaining resources in the timeslot to one of the first RAT and the second RAT that is not prioritized in the respective timeslot of the selected prioritization pattern.

4. The method of claim 3, further comprising:
providing, to the first scheduler of the first RAT, information that indicates the radio resources in the timeslot that are assigned to the first RAT; and
providing, to the second scheduler of the second RAT, information that indicates the radio resources in the timeslot that are assigned to the second RAT

5. The method of claim 2, further comprising:
determining, for a second observation window comprising the second plurality of timeslots, a second value of the traffic or demand related metric based on scheduling requests received from the first scheduler for the first RAT during the second observation window and scheduling requests received from the second scheduler for the second RAT during the second observation window;
selecting a new prioritization pattern from the set of two or more prioritization patterns based on the second value of the traffic or demand related metric determined for the second observation window; and
performing, for a third plurality of timeslots, radio resource allocation for the first scheduler for the first RAT and the second scheduler for the second RAT based on the selected new prioritization pattern.

6. The method of claim 1, wherein, for each prioritization pattern in the set of two or more prioritization patterns, the number of first timeslots and the number of second timeslots in the prioritization pattern is a function of the associated value of the traffic or demand related metric.

7. The method of claim 1, wherein selecting the prioritization pattern from the set of two or more prioritization patterns based on the determined value of the traffic or demand related metric for the first observation window comprises:
selecting one of the set of two or more prioritization patterns for which the associated traffic or demand related metric most closely matches the traffic or demand related metric for the first observation window as the prioritization pattern to be used for performing radio resource allocation for the first scheduler for the first RAT and the second scheduler for the second RAT.

8. The method of claim 1, wherein selecting the prioritization pattern from the set of two or more prioritization patterns based on the determined value of the traffic or demand related metric for the first observation window comprises:
selecting at least two candidate prioritization patterns from the set of two or more prioritization patterns based on the associated traffic or demand related metrics and the traffic or demand related metric for the first observation window;
for each candidate prioritization pattern from the at least two candidate prioritization patterns, assigning a weight to the candidate prioritization pattern based on the associated traffic or demand related metric and the traffic or demand related metric for the first observation window; and
selecting the prioritization pattern to be used for performing radio resource allocation for the first scheduler for the first RAT and the second scheduler for the second RAT from the at least two candidate prioritization patterns in such a manner that a probability of selecting each candidate prioritization pattern of the at least two candidate prioritization patterns is a function of the weight assigned to the candidate prioritization pattern.

9. The method of claim 1, wherein determining the value of the traffic or demand related metric for the first observation window comprises:
for each timeslot of the first plurality of timeslots comprised in the first observation window, determining a value of the traffic or demand related metric for the timeslot based on scheduling requests received from the first scheduler for the first RAT for the timeslot and scheduling requests received from the second scheduler for the second RAT for the timeslot; and
combining the values of the traffic or demand related metric for the first plurality of timeslots to provide the value of the traffic or demand related metric for the first observation time window.

10. The method of claim 9, wherein combining the values of the traffic or demand related metric for the first plurality of timeslots to provide the value of the traffic or demand related metric for the first observation time window comprises averaging the values of the traffic or demand related metric for the first plurality of timeslots to provide the value of the traffic or demand related metric for the first observation time window as an average value of the traffic or demand related metric.

11. The method of claim 9, wherein, for each timeslot of the first plurality of timeslots comprised in the first observation window, determining the value of the traffic or demand related metric for the timeslot is further based on priorities assigned to traffic associated to the scheduling requests received from the first scheduler for the first RAT for the timeslot and priorities assigned to traffic associated to the scheduling requests received from the second scheduler for the second RAT for the timeslot.

12. The method of claim 1, wherein the traffic or demand related metric for the first observation window is an average ratio of a number of radio resources needed to satisfy the scheduling requests from the first scheduler for the first RAT to a number of radio resources needed to satisfy the scheduling requests from the second scheduler for the second RAT per timeslot.

13. The method of claim 1, wherein the traffic or demand related metric for the first observation window is an average ratio of a number of radio resources needed to satisfy the scheduling requests from the second scheduler for the second RAT to a number of radio resources needed to satisfy the scheduling requests from the first scheduler for the first RAT per timeslot.

14. The method of claim 1, wherein the traffic or demand related metric for the first observation window is an average ratio of a number of radio resources needed to satisfy the scheduling requests from the first scheduler for the first RAT to a total number of radio resources needed to satisfy the scheduling requests from both the first scheduler for the first RAT and the second scheduler for the second RAT, per timeslot.

15. The method of claim 1, wherein the traffic or demand related metric for the first observation window is an average ratio of a number of radio resources needed to satisfy the scheduling requests from the second scheduler for the second RAT to a total number of radio resources needed to satisfy the scheduling requests from both the first scheduler for the first RAT and the second scheduler for the second RAT, per timeslot.

16. The method of claim 1, wherein the traffic or demand related metric for the first observation window is based on:
a) priorities of the first RAT and the second RAT;
b) buffer size of UE data buffers of UEs of the first RAT and buffer sizes of UE data buffers of UEs of the second RAT;
c) number of UEs of the first RAT and number of UEs of the second RAT;
d) number of data radio bearers across UEs of the first RAT and number of data radio bearers across UEs of the second RAT; or
e) a combination of any two or more of (a)-(d).

17. (canceled)

18. (canceled)

19. A network node for User Equipment (UE) aware radio resource allocation for dynamic spectrum sharing between a first scheduler for a first Radio Access Technology (RAT) and a second scheduler for a second RAT, the network node comprising processing circuitry configured to cause the network node to:
determine, for a first observation window comprising a first plurality of timeslots, a value of a traffic or demand related metric based on scheduling requests received from the first scheduler for the first RAT during the first observation window and scheduling requests received from the second scheduler for the second RAT during the first observation window;
select a prioritization pattern from a set of two or more prioritization patterns based on the determined value of the traffic or demand related metric for the first observation window, wherein:
each prioritization pattern in the set of two or more prioritization patterns is associated to a different value of the traffic or demand related metric;
each prioritization pattern in the set of two or more prioritization patterns defines a pattern of first timeslots in which the first RAT is prioritized and second timeslots in which the second RAT is prioritized; and
perform radio resource allocation for the first scheduler for the first RAT and the second scheduler for the second RAT based on the selected prioritization pattern.

20. A non-transitory computer-readable medium comprising instructions for execution by processing circuitry of a network node for User Equipment (UE) aware radio resource allocation for dynamic spectrum sharing between a first scheduler for a first Radio Access Technology (RAT) and a second scheduler for a second RAT, whereby the processing circuitry causes the network node to:
determine, for a first observation window comprising a first plurality of timeslots, a value of a traffic or demand related metric based on scheduling requests received from the first scheduler for the first RAT during the first observation window and scheduling requests received from the second scheduler for the second RAT during the first observation window;
select a prioritization pattern from a set of two or more prioritization patterns based on the determined value of the traffic or demand related metric for the first observation window, wherein:
each prioritization pattern in the set of two or more prioritization patterns is associated to a different value of the traffic or demand related metric;
each prioritization pattern in the set of two or more prioritization patterns defines a pattern of first timeslots in which the first RAT is prioritized and second timeslots in which the second RAT is prioritized; and
perform radio resource allocation for the first scheduler for the first RAT and the second scheduler for the second RAT based on the selected prioritization pattern.
